(19) United States
(12) Patent Application Publication
(10) Pub. No.: US 2025/0008490 A1
(43) Pub. Date: Jan. 2, 2025

(54) COMMUNICATION PARAMETERS FOR ENERGY HARVESTING DEVICES

(71) Applicant: QUALCOMM Incorporated, San Diego, CA (US)

(72) Inventors: Ahmed ELSHAFIE, San Diego, CA (US); Ahmed Attia ABOTABL, San Diego, CA (US); Alexandros MANOLAKOS, Athens (GR)

(21) Appl. No.: 18/709,778

(22) PCT Filed: Sep. 15, 2022
(86) PCT No.: PCT/US2022/076478

§ 371 Date: May 13, 2024

(30) Foreign Application Priority Data
Jan. 7, 2022 (GR) 20220100015

(51) Int. Cl. H04W 72/044; H04L 1/00; H04L 5/00; H04W 72/40

(52) U.S. Cl. CPC H04W 72/044; H04L 1/0057; H04L 5/001; H04W 72/40

(57) ABSTRACT

This disclosure provides methods, devices and systems for communicating with an energy harvesting (EH) user equipment (UE). The EH UE may have limited power available for communications depending on an energy mode of the EH UE. The EH UE transmits an indication of an EH communication parameter to a scheduling device. The EH communication parameter may be a maximum time-frequency resource size for one or more physical channels during a time period based on an energy mode of the UE for the time period. The scheduling device schedules the UE transmit or receive a signal satisfying the maximum time-frequency resource size on the one or more physical channels. In some implementations, the scheduling device or another network device may provide radio frequency energy that the EH UE may harvest to power the EH UE for the communications.

### CROSS REFERENCE TO RELATED APPLICATIONS

This application claims priority to Greek Application Number 20220100015 entitled “COMMUNICATION PARAMETERS FOR ENERGY HARVESTING DEVICES” and filed on Jan. 7, 2022, which is assigned to the assignee hereof, and incorporated herein by reference in its entirety.

### BACKGROUND

### Technical Field

The present disclosure relates generally to communication systems, and more particularly, to apparatuses and methods for setting transmission parameters for energy harvesting devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the present disclosure provides a method, apparatus, and non-transitory computer readable medium for wireless communication for a user equipment (UE). The method includes transmitting an indication of a maximum time-frequency resource size for one or more physical channels during a time period based on an energy mode of the UE for the time period. The method includes transmitting or receiving a signal satisfying the maximum time-frequency resource size on the one or more physical channels.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the present disclosure provides a method, apparatus, and non-transitory computer readable medium for wireless communication with an energy harvesting (EH) UE. The method includes receiving, from the UE, an indication of a maximum time-frequency resource size for one or more physical channels during a time period based on an energy mode of the UE for the time period. The method includes transmitting or receiving a signal satisfying the maximum time-frequency resource size on the one or more physical channels.

The disclosure also provides an apparatus (e.g., abase station) including a memory storing computer-executable instructions and at least one processor configured to execute the computer-executable instructions to perform the above method, an apparatus including means for performing the above method, and a non-transitory computer-readable medium storing computer-executable instructions for performing the above method.

In an aspect, the present disclosure provides a method, apparatus, and non-transitory computer readable medium for wireless communication for a UE. The method includes transmitting an indication of an energy mode parameter on a bandwidth part (BWP) configured with a plurality of time and frequency occasions, wherein the indication is a sequence and selection of a time and frequency occasion from the plurality of time and frequency occasions identifies the energy mode parameter. The method includes receiving harvestable energy from one or more network devices in response to the indication.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

To the accomplishment of the foregoing and related ends, the one or more aspects comprise the features hereinafter described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first 5G NR frame.

FIG. 2B is a diagram illustrating an example of DL channels within a 5G NR subframe.

FIG. 2C is a diagram illustrating an example of a second 5G NR frame.

FIG. 2D is a diagram illustrating an example of UL channels within a 5G NR subframe.

FIG. 3 is a diagram illustrating an example of a base station and user equipment (UE) in an access network.

FIG. 4A is a diagram illustrating a first example hardware architecture for energy harvesting.

FIG. 4B is a diagram illustrating a second example hardware architecture for energy harvesting.

FIG. 5 is a diagram illustrating an example component carrier (CC) and bandwidth part (BWP) for energy harvesting indications.

FIG. 6 is a message diagram illustrating example communications of a base station and a UE.

FIG. 7 is a conceptual data flow diagram illustrating an example data flow between different means/components in an example UE including an energy harvesting (EH) component.

FIG. 8 is a conceptual data flow diagram illustrating an example data flow between different means/components in an example base station including a EH signaling component.

FIG. 9 is a flowchart of an example method of indicating communication parameters for an EH UE.

FIG. 10 is a flowchart of an example method of communicating with an EH UE.

FIG. 11 is a flowchart of an example method 1100 for harvesting energy at a UE

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Wireless communications systems have conventionally focused on improved quality for premium services such as enhanced mobile broad band (eMBB), ultra-reliable low latency communication (URLLC), and vehicle to anything (V2X) services. There is also a need to provide service for reduced capability (RedCap) devices such as wearables, industrial wireless sensor networks, surveillance cameras, and low-end smartphones. For such RedCap devices, metrics such as peak throughput, bandwidth, latency, and reliability may be less important than efficiency and cost improvements. One example service for RedCap devices is low power wide area (LPWA) communications with improvements to coverage with reduced complexity and power consumption. Example use cases for LPWA communications include metering devices, asset tracking, and Internet of Things (IoT). One technique to provide reduced power consumption is energy harvesting.

Energy harvesting (EH) may broadly include different physical mechanisms such as solar, thermal, wind, and kinetic. EH may allow for zero-energy devices, where the energy for the device is obtained from ambient energy without the need for battery replacement or charging. For example, using radio frequency (RF) based energy harvesting, a device may obtain energy from wireless waveforms over the air. In comparison to other physical mechanisms, the RF energy harvesting may be more flexible as an RF signal can be used under various conditions such as indoors, at night, and while stationary. An EH device may be referred to as passive IOT, zero power IOT, ambient IOT, passive RFID, semi-passive RFID, active RFID, or reduced capability user equipment (UE).

One issue with EH devices is that the power available to an EH device at any time may vary depending on conditions for the available EH mechanisms of the device. For example, in some scenarios, a UE may operate in a mode with little power, but may need to perform some signaling to establish communications or request RF based energy harvesting from the network.

In an aspect, a low power device such as a UE can be assigned a small bandwidth part (BWP) or resource block (RB) allocation. In addition, within a period of time, the UE can be assigned only few symbols for transmission or reception. The small number of resources may allow the UE to harvest energy between communications. Additionally, using narrow band allocations such as a single resource element, a single RB, or a few RBs may reduce the peak to average power ratio (PAPR) per UE for uplink transmission on a service link. An EH device could implement one or more methods for EH such as solar, vibration, RF/wireless. An energy mode may define an amount of energy available for the UE and may be agnostic to the particular method of EH. An energy mode may also be referred to as a power mode. In some cases, energy mode can include or take into account at least one of energy state or energy state profile, charging rate (or energy arrival rate) profile, discharging or power consumption rate (energy departure rate) profile. For example, a charging/discharging/state profile can include one or more values of past, current, or future charging/discharging rates or energy states during past, current, or future time durations or periods. In some cases, a charging/discharging/state profile can be a single value taking into account current charging rate or discharging rate or energy state at the UE.

In an aspect, the present disclosure provides techniques for limiting the resources and processing of a UE based on an energy mode. For example, the resources may be limited to a maximum time-frequency resource size for one or more physical channels during a time period based on the energy mode of the UE for the time period. The processing of the UE may be limited by capping a transport block size, modulation and coding scheme (MCS), or number of decoding iterations.

For example, in one use case, a turbo hybrid automatic repeat request (HARQ) protocol may include feedback of a change in MCS (delta-MCS) for a transport block received with a particular MCS index. The delta-MCS may be calculated based on a difference between a target MCS index the particular MCS index for the transport block. The target MCS may be the largest MCS index smaller than or equal to a block error rate (BLER) target for a number of decoding iterations. A limit on the number of decoding iterations may result in a lower delta-MCS.

In an aspect, the UE may be configured with a specific component carrier and bandwidth part (BWP) for monitoring signaling related to EH such as an energy mode or for indicating charging rate requests. The BWP may be configured with time-frequency occasions on which the UE may transmit a single bit using a sequence based signal that uses low power. For instance, a transmission on one of the time-frequency occasions may indicate a current energy mode, a request for RF energy for EH, or a request to activate or deactivate component carriers or BWPs.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

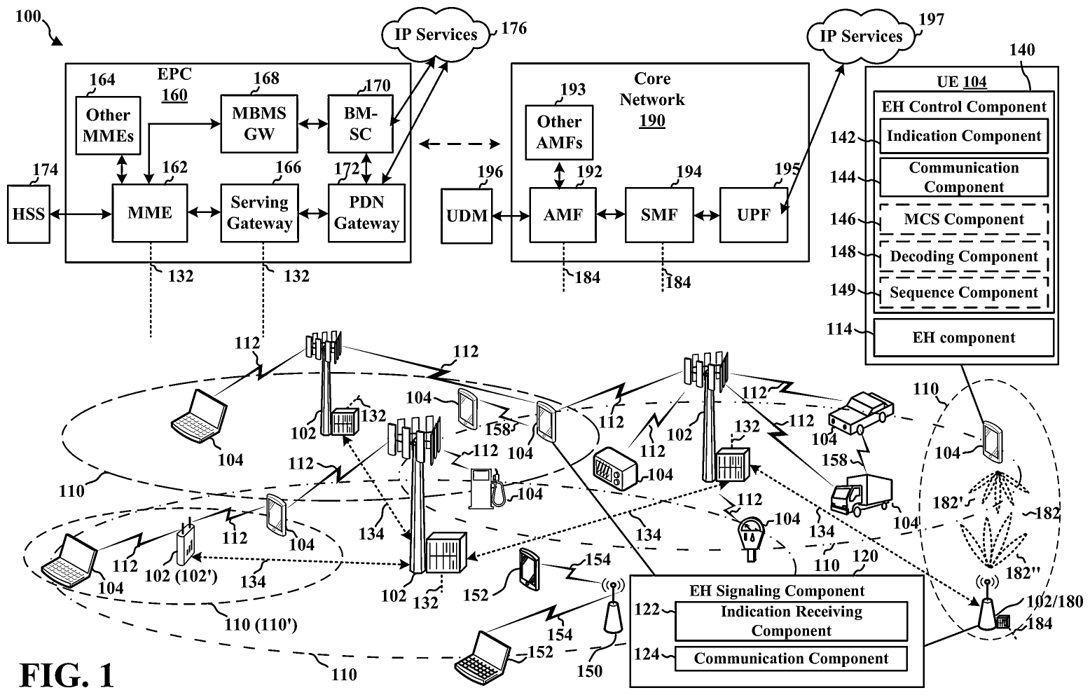

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

In an aspect, one or more of the UEs 104 may include an energy harvesting (EH) component 114 for harvesting energy and an EH control component 140 for signaling based on an energy mode of the UE 104. The EH control component 140 may include an indication component 142 configured to transmit an indication of a maximum time-frequency resource size for one or more physical channels during a time period based on an energy mode of the UE for the time period. The EH control component 140 may include a communication component 144 configured to transmit or receive a signal satisfying the maximum time-frequency resource size on the one or more physical channels. The EH control component 140 may optionally include a MCS component 146 configured to indicate a maximum transport block size, a maximum MCS, or a maximum coding rate. The EH control component 140 may optionally include a decoding component 148 configured to indicate a maximum number of coding iterations based on the energy mode. The EH control component 140 may optionally include a sequence component 149 configured to transmit the indication as a sequence on a selected one of the time and frequency occasions.

In an aspect, one or more scheduling devices (e.g., a base station 102 or another UE 104 scheduling sidelink communications) may include an EH signaling component 120 configured to schedule communications with an EH UE. The EH signaling component 120 may include an indication receiving component 122 configured to receive, from the UE, an indication of a maximum time-frequency resource size for one or more physical channels during a time period based on an energy mode of the UE for the time period. The EH signaling component 120 may include a communication component 124 configured to transmit or receive a signal satisfying the maximum time-frequency resource size on the one or more physical channels.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 112 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 112 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). A D2D communication link 158 using sidelink channels may be referred to as a PC5 interface or PC5 reference point. D2D communication may be through a variety of wireless D2D communications systems, such as for example, FlashLinQ, WiMedia, Bluetooth, ZigBee, Wi-Fi based on the Institute of Electrical and Electronics Engineers (IEEE 802.11) standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a packet switched (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies.

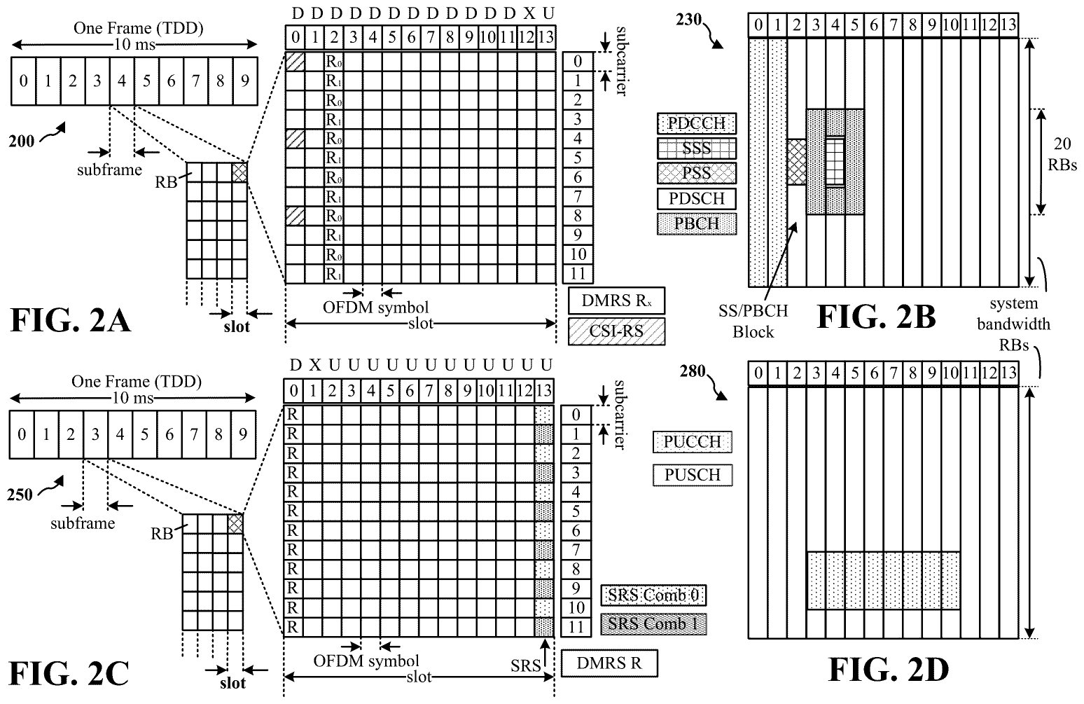

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be frequency domain duplexed (FDD) in which for a particular set of subcarriers (carrier system bandwidth), subframes within the set of subcarriers are dedicated for either DL or UL, or may be time domain duplexed (TDD) in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

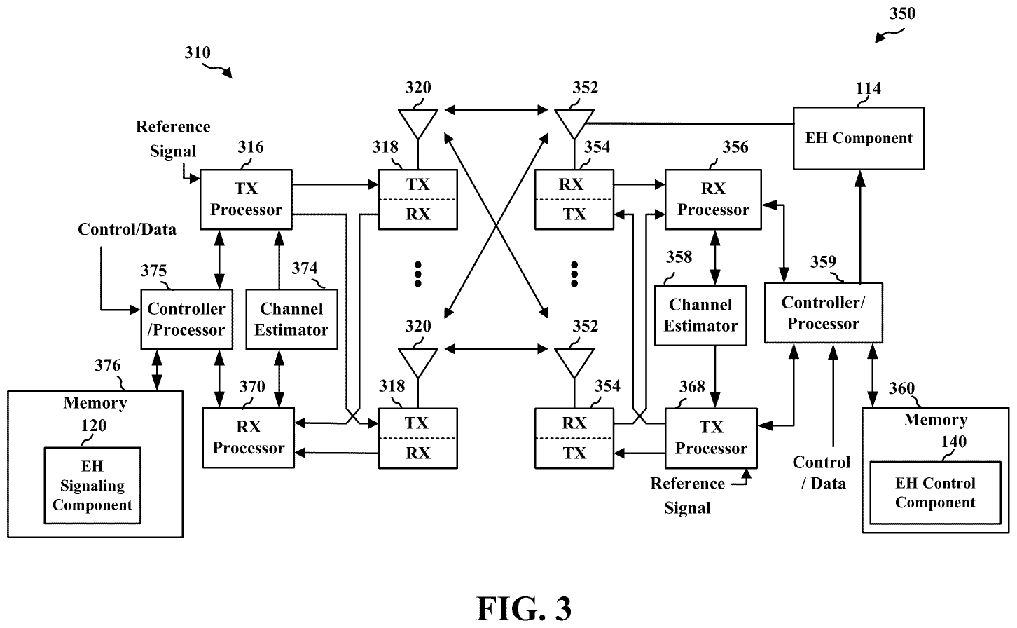

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with, and coupled to, a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an acknowledge (ACK) and/or negative acknowledge (NACK) protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with, and coupled to, a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In an aspect, the UE 350 may include a EH component 114. The EH component 114 may be a circuit configured to harvest RF energy and store the harvested energy. The EH component 114 may include an RF to DC circuit configured to convert RF energy to DC current. The EH component 114 may include a battery or capacitor for storing the harvested energy. The EH component 114 may be coupled to one or more of the antennas 352. In some implementations, the EH component 114 may include a separate antenna. The EH component 114 may be controlled by the controller/processor 359 executing the EH control component 140.

At least one of the TX processor 368, the RX processor 356, and the controller/processor 359 may be configured to perform aspects in connection with the EH control component 140 of FIG. 1. For example, the memory 360 may include executable instructions defining the EH control component 140. The TX processor 368, the RX processor 356, and/or the controller/processor 359 may be configured to execute the EH control component 140.

At least one of the TX processor 316, the RX processor 370, and the controller/processor 375 may be configured to perform aspects in connection with the EH signaling component 120 of FIG. 1. For example, the memory 376 may include executable instructions defining the EH signaling component 120. The TX processor 316, the RX processor 370, and/or the controller/processor 375 may be configured to execute the EH signaling component 120.

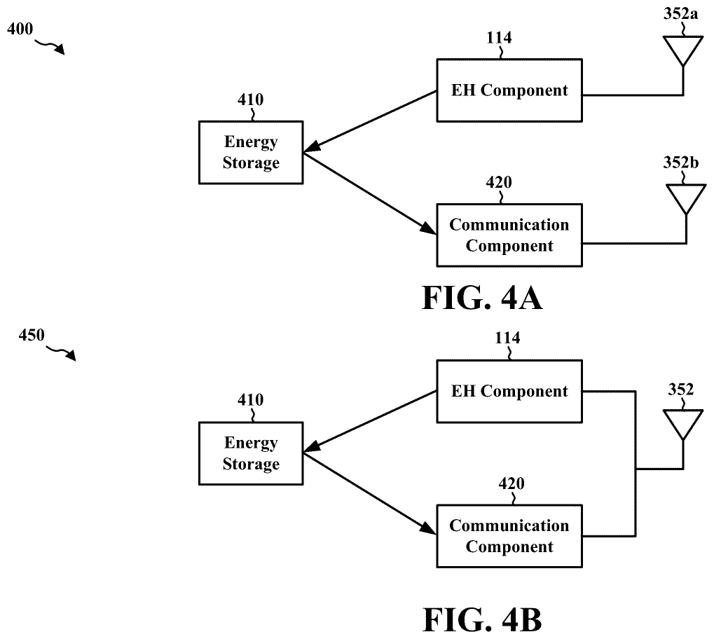

FIG. 4A is a schematic diagram illustrating a first example hardware architecture 400 for energy harvesting. The architecture 400 may include separate antennas 352a and 352b for energy harvesting and communications. The antenna 352a may be connected to the EH component 114. The antenna 352b may be connected to a communication component 420. The communication component 420 may include, for example, one or more transceivers (e.g., RX/TX 354), the channel estimator 358, the RX processor 356, and the TX processor 368. The EH component 114 may be connected to an energy storage 410, which may include, for example, a capacitor and/or a battery. The EH component 114 may charge the energy storage 410 with energy harvested from RF signals received via the antenna 352a. The energy storage 410 may provide energy to the communication component 420.

FIG. 4B is a schematic diagram illustrating a second example hardware architecture 450 for energy harvesting. The architecture 450 may include a shared antenna 352 for energy harvesting and communications. Energy received on the antenna 352 may be shared between the EH component 114 and the communication component 420. As in the architecture 400, the EH component 114 may be connected to an energy storage 410 and charge the energy storage 410 with energy harvested from RF signals received via the antenna 352. The energy storage 410 may provide energy to the communication component 420 (e.g., for processing the received RF signals or transmitting RF signals).

In some implementations, the hardware architecture 450 may operate according to a time-switching RF-EH scheme. The time-switching architecture allows the network node to switch between the information receiver and the RF energy harvester. The energy harvested at a receiver j from source I can be expressed as Eⱼ=ηPᵢ|gᵢ₋ⱼ|²αT, where 0≤α≤1 is the fraction of time allocated for energy harvesting. Letting κ and W denote the noise spectral density and channel bandwidth, the data rate may be expressed as

$${R}_{i - j} = ( 1 - α ) {log}_{2} ( 1 + \frac{{\vert {g}_{1 - j} \vert}^{2} {P}_{i}}{κ W} ) .$$

In some implementations, the hardware architecture 450 may operate according to a power-splitting architecture, where the received RF signals are split into two streams for the communication component 420 and EH component 114 with different power levels. The energy harvested at receiver j from source i can be calculated as Eⱼ=ηρPᵢ|gᵢ₋ⱼ|²T, where 0≤ρ≤1 is the fraction of power allocated for energy harvesting.

In an aspect, an EH IoT device or UE can indicate a maximum time-frequency resource size for one or more physical channels during a period of time. For example, the physical channels may be control channels or data channels such as: PDCCH, PDSCH, PUSCH, PSCCH, or PSSCH. The period of time may be specified as number (X) of time units such as slots or milliseconds (ms). The time-frequency resource size may be specified in terms of a number of REs or RBs and a number of OFDM symbols. The maximum time-frequency resource size and the number of time units may be on capabilities of the UE as well as an energy mode for the period of time. For example, the energy mode may be based on an active EH method or battery status, either of which may change over time. The UE may send a new indication in response to a change in energy mode. In some implementations, a minimum separation in time between signals based on the energy mode, and wherein transmitting or receiving the signal is based on a dynamic grant, semi-persistent scheduling, or configured grant that schedules at least the minimum separation in time between signals based on the indication

In some implementations, the indication may identify the time-frequency resource size from a configured set of time-frequency resource combinations. For example, a base station may configure multiple block sizes. As another example, a regulation or standards document may define preconfigured blocks of potential sizes for EH devices where a block is defined by a certain number of REs or RBs and a certain number of OFDM symbols. The UE may select an index of the configured set of time-frequency resource combinations to be activated from time to time.

In some implementations, the UE may transmit the indication of the maximum time-frequency resource size in an RRC message (e.g., as a user assistance information element), a media access control (MAC) control element (CE) (MAC-CE), a physical uplink control channel (PUCCH), or physical uplink shared channel (PUSCH) resources on a Uu link with the base station. For sidelink physical channels, the UE may transmit the indication of the maximum time-frequency resource size on PC5-RRC, MAC-CE, physical sidelink feedback channel (PSFCH), or dedicated physical sidelink shared channel (PSSCH) resources (e.g., sidelink control information (SCI-2) carried in PSSCH). In sidelink, the indication may correspond to a resource pool for sidelink communications. The physical channel (e.g., PSSCH) may be received on resources selected from the resource pool.

In an aspect, the indication may also indicate limits on processing at the UE. For example, the indication may further indicate a maximum transport block size (TBS), a maximum MCS, or a maximum coding rate. As another example, the indication may indicate a maximum number of coding iterations based on the energy mode. The limits on processing may require the UE to monitor or transmit on fewer resources and reduce a maximum power needed.

In an aspect where turbo HARQ, i.e., CSI derived based on PDSCH, is used, the UE can determine the CSI based on the maximum number of coding iterations. Similarly, the delta-MCS or a reported signal to interference plus noise ratio (SINR) may be based on fewer MCS possibilities according to the identified maximum MCS. A number of bits of the CSI may be based on a number of supported MCSs for the energy mode. In some implementations, the base station may request the UE to use a certain number of decoding iterations (e.g., LDPC iterations) to derive CSI. When the UE has reported a maximum number of decoding iterations, the UE may generate an error in response to the requested LDPC iteration being greater than the maximum number of decoding iterations, or send the CSI based on the maximum number of decoding iterations. The UE can change the value of the maximum number of coding iterations in response to a change in the energy mode of the UE.

In some implementations, the indication may include a minimum separation in time between signals of a same or different type based on the energy mode. For example, the UE may only be scheduled to transmit or receive with the period of time between transmission/reception occasions. This indication may help the base station to configure the uplink or sidelink configured grant (CG) periodicities (i.e., time separation between two CG occasions/allocations) or the downlink semi-persistent scheduling (SPS) periodicities. In addition, this indication from EH UE may help a transmitting node (base station/UE) to configure an EH IoT dynamic grant or CG transmission or reception allocation for that UE after transmitting/receiving another SPS or dynamic grant allocation to or from that UE. The base station may provide a dynamic grant, semi-persistent scheduling, or configured grant that schedules at least the minimum separation in time between signals based on the indication.

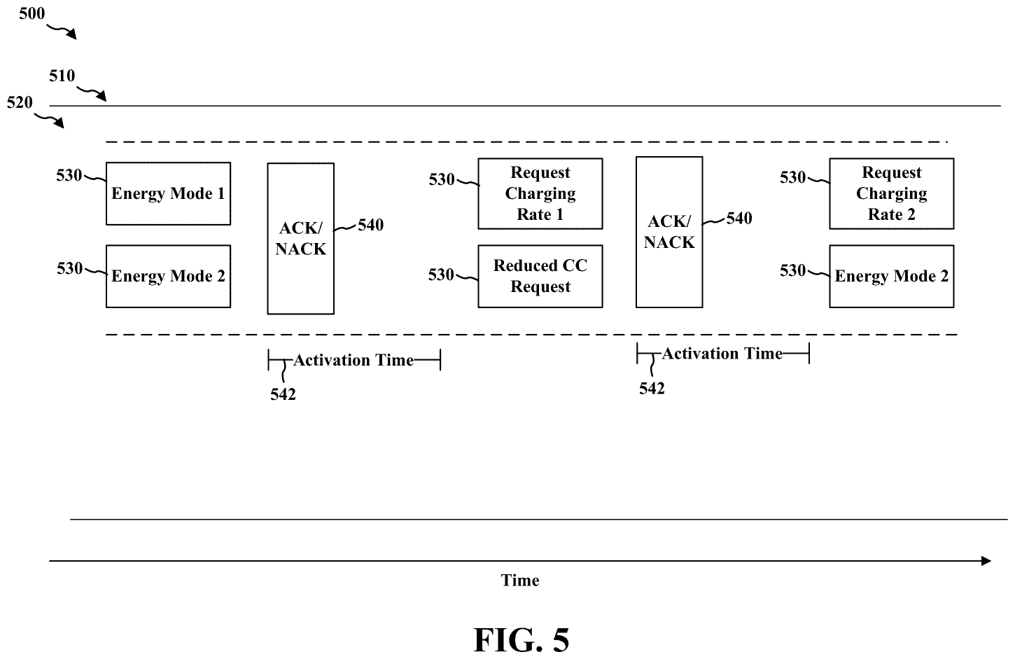

FIG. 5 is a resource diagram 500 illustrating an example component carrier (CC) 510 and bandwidth part (BWP) 520 for energy harvesting indications. An EH-UE may be configured with the CC 510 for monitoring EH related tasks. The UE may initially be configured with the BWP 520 as a default BWP with a low bandwidth (e.g., less than 10 RBs). The CC 510 may serve multiple UEs, each of which may be configured with a BWP based on capability and/or a current energy mode. Although the CC 510 and BWP 520 may carry indications related to RF EH, the CC 510 and BWP 520 may more generally carry information related to the energy mode of EH UEs. For example, an EH-UE with solar EH capabilities may indicate an energy mode corresponding to a current charging rate.

In an aspect, the CC 510 and BWP 520 may be configured with time and frequency occasions 530. Each time and frequency occasion 530 may include resources for a UE to transmit a single bit indication as a sequence. Selection of the time and frequency occasion 530 may correspond to the indication sent by the UE. For example, various time and frequency occasions may be configured to indicate different energy modes, requests for charging rates, or requests to reduce configured CCs for the UE. In some implementations, each UE may transmit the sequence with a different cyclic shift such that indications from multiple UEs may be multiplexed on the time and frequency occasions 530.

The base station 102 may transmit an ACK/NACK 540 in response to an indication received on a time and frequency occasion 530. An ACK may indicate that the base station has accepted the request and will change operating parameters after an activation time 542. In some implementations, the ACK/NACK 540 may signal the activation time 542.

As an example use case, a UE 104 may transmit a sequence on the time and frequency occasion 530 indicating an energy mode 2 (e.g., indicating a relatively greater available power such as from a solar charging source). The base station 102 may receive the sequence and identify the UE 104. The base station may transmit the ACK 540 and switch to a configuration corresponding to energy mode 2 for the UE after the activation time 542. For instance, the configuration corresponding to energy mode 2 may activate an additional data CC or configure a wider BWP. In contrast, if the indication corresponds to a lower energy mode or is a request to reduce configured CCs for the UE, the base station may reduce the data CCs active for the UE. For example, the base station may deactivate a set of configured CCs or put the CCS in a dormant stat. For instance, a configuration of the CC may indicate in which energy modes the CC is active or dormant. As another example, the base station may reduce a BWP size per CC. As a third example, the base station may reduce a number of BWPs that are active per CC. That is, the configuration of the BWP may indicate in which power states the BWP is active. In addition, the base station may change the size of the “currently active” BWP as well. For example, the base station may make the BWP smaller or larger based on an indicated energy mode. In another example use case, in response to a request for charging rate, the base station may transmit or request another network device to transmit an RF signal that can be harvested by the UE.

The time and frequency occasions 530 may be configured (e.g., via RRC signaling) or preconfigured (e.g., via standardization) with certain periodic (semi-persistent) occasions to report a request of moving to low energy mode. The UE may autonomously use the time and frequency occasions 530 to request wireless power from the network if the network supports, e.g., RF or laser/light charging. As another example, the UE may request to deactivate a set CCs or BWPs for either data or energy or both. In some implementations, the indication can also include how much energy the UE needs for charging to a certain power state or battery level. For example, the indication may be transmitted on a time and frequency occasion 530 corresponding to a first battery level or a time and frequency occasion 530 corresponding to a second battery level. In some implementations, different radio network temporary identifiers (RNTIs) can be used by UE to separate different modes.

In some implementations, the base station can configure the UE with other dedicated occasions within the CC (and BWP associated with that CC) so that the UE sends another indication when the UE has reached a higher charge level (e.g., from EH techs such as solar, vibration, RF) so that the UE will use or reuse the deactivated CCs. That is, there may be a set of occasions for requesting to move to a low energy mode, another set of occasions to move to a second energy mode, and a third set of occasions for a third energy mode. Each of these modes can be associated with a charging rate that is expected to be delivered by the base station or another network device (e.g., another UE or consumer premises equipment (CPE)) assigned by the base station. In addition, there could be time and frequency occasions 530 for requesting different charging rates.

In an aspect, the coding rate of the sequences transmitted on the time and frequency occasions is very low (e.g., a single bit transmitted over one or more RBs) and can be transmitted with very low power. Accordingly, a UE with a low charge state or a zero-energy device may be able to transmit an indication using only harvested energy. The indication may allow the UE to operate in a low energy mode using the available energy from harvesting, or increase the RF energy available for the UE to harvest for operation in a higher energy mode.

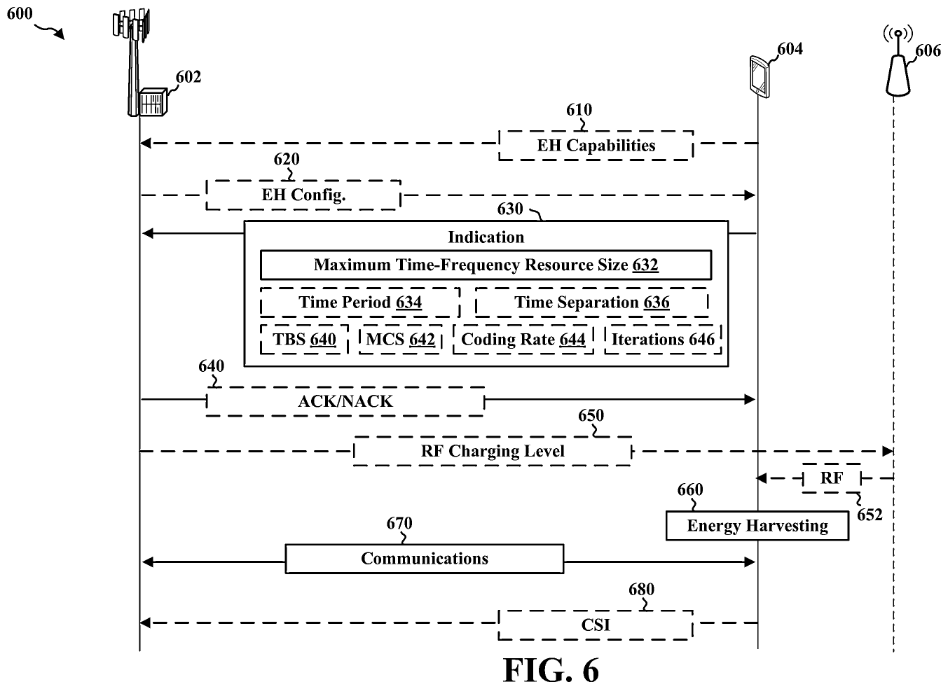

FIG. 6 is a diagram 600 illustrating example communications of a base station 602 and a UE 604 configured to harvest energy. The base station 602 includes the EH signaling component 120. The UE 604 includes the EH component 114 and the EH control component 140. The UE 604 may be referred to as passive IOT, zero power IOT, ambient IOT, passive RFID, semi-passive RFID, active RFID, or reduced capability (RedCap) UE.

In some implementations, the UE 604 may optionally transmit EH capabilities 610. The EH capabilities 610 may provide information about the energy harvesting capabilities of the UE 604 such as EH technologies and charging rates associated with each EH technology. The EH capabilities 610 may define capabilities according to one or more energy modes. For example, the EH capabilities 610 may associate a maximum time-frequency resource size for one or more physical channels and/or a time period with different energy modes.

In some implementations, the base station 602 may transmit an EH configuration 620. The EH configuration 620 may configure the CC 510 and/or BWP 520. For example, the EH configuration 620 may define the indications associated with each time and frequency occasion 530. The EH configuration 620 may be, for example, an RRC configuration message. In other implementations, the EH configuration 620 may be at a physical layer, for example, as a DCI on the Uu link or a SCI on the sidelink, or the EH configuration 620 may be multiplexed with a Uu wake up signal (WUS) or SL WUS. The EH configuration 620 may be a dedicated PDSCH or a dedicated PSSCH. In some implementations, the EH configuration 620 may be transmitted as a MAC-CE.

The UE 604 may transmit an indication 630 of a maximum time-frequency resource size 632. In some implementations, for the Uu link (e.g., uplink or downlink physical channels) the UE 604 transmits the indication 630 as an RRC message, a MAC-CE, a PUCCH, or a PUSCH. In some implementations, the indication 630 may be multiplexed multiplexed with another physical layer transmission such as: a HARQ-ACK of one or more of downlink transmissions carried on PUCCH, a scheduling request (SR), a buffer state information (BSR), or a random-access message (e.g., msgl or msg3 in a 4-step RACH procedure or msgB in a 2-step RACH procedure). For sidelink physical channels, the UE 604 may transmit the indication 630 as a PC5-RRC message, a PC5 MAC-CE, a dedicated physical sidelink feedback channel (PSFCH), a physical sidelink shared channel (PSSCH), a physical sidelink control channel (PSCCH), or information multiplexed with a HARQ-ACK of one or more PSSCH. In some implementations, the indication 630 of the maximum time-frequency resource size 632 may be indicated as an index of a pre-defined set of time-frequency resource combinations. For example, the indices may be defined by the EH configuration 620 based on the EH capabilities 610. In implementations where the UE 604 transmits the indication 630 on the CC 510 and BWP 520, the maximum time-frequency resource size 632 may be indicated by an energy mode corresponding to a selected time and frequency occasion 530.

In some implementations, the indication 630 may include a time period 634 to which the maximum time-frequency resource size 632 applies. That is, the UE may be able to transmit or receive on resources up to the maximum time-frequency resource size 632 during the time period 634. For example, the time period 634 may be a number of slots, sub-frames, or frames. In some implementations, the indication 630 may further include a time separation 636, which may be different than the time period 634. The time separation 636 may define a minimum time between communications of the UE 604. For example, even if the UE 604 can receive the maximum time-frequency resource size 632 during the time period 634, the UE 604 may require the time separation 636 to recharge between communications.

In some implementations, the indication 630 may include one or more of a maximum TBS 640, a maximum MCS 642, or a maximum coding rate 644. In some implementations, the indication 630 may include a maximum number of coding/decoding iterations 646. The parameters such as maximum TBS 640, a maximum MCS 642, or a maximum coding rate 644, and maximum number of coding/decoding iterations 646 may limit the power consumed by the UE 604 for a particular communication. Accordingly, by indicating the maximum parameters for a communication, the UE 604 ensure availability of sufficient energy for the communication.

The base station 602 may optionally transmit an ACK/NACK 640 regarding the indication 630. In some implementations, the ACK/NACK 640 may include the activation time 542.

In some implementations where the UE 604 has requested a charging rate for RF charging, the base station 602 may transmit an indication of an RF charging level 650 to a network device 606. For example, the network device 606 may be another UE or a CPE that is located closer to the UE 604 than the base station 602. The indication of the RF charging level 650 may instruct the network device 606 to provide an RF signal 652 that the UE 604 can use for energy harvesting.

The UE 604 may perform energy harvesting at block 660. For example, the UE 604 may harvest energy from the RF signal 652 via the EH component 114. The harvested energy may be used to charge an energy storage 410 for use in current or later communications.

The base station 602 and the UE 604 may transmit and receive communications 670. The communications 670 may include signals that satisfy the maximum time-frequency resource size 632 on the one or more physical channels. The 670 may also satisfy any other maximum parameters indicated in the indication 630.

In some implementation, the UE 604 may transmit a CSI 680. The CSI 680 may be based on the communications 670 such as a PDSCH. The UE 604 may determine an index corresponding to a MCS or delta-MCS that the UE is able to receive at a target block error rate. In an aspect, indicated parameters such as the maximum number of decoding iterations 646 may affect the CSI 680. For example, if the UE 604 has indicated a maximum MCS 642, the range of the index may be limited and a number of bits of the CSI 680 may be based on a number of supported MCS for the energy mode. In some implementations, the communications 670 may include an indication of a low density parity code (LDPC) iteration for the CSI 680. If the UE 604 has indicated a number of iterations 646 and the indicated LDPC iteration is greater than the indicated number of iterations 646, the UE 604 may transmit the CSI 680 based on the indicated number of iterations 646. Alternatively, the UE 604 may generate an error in response to the indicated LDPC iteration being greater than the maximum number of iterations 646.

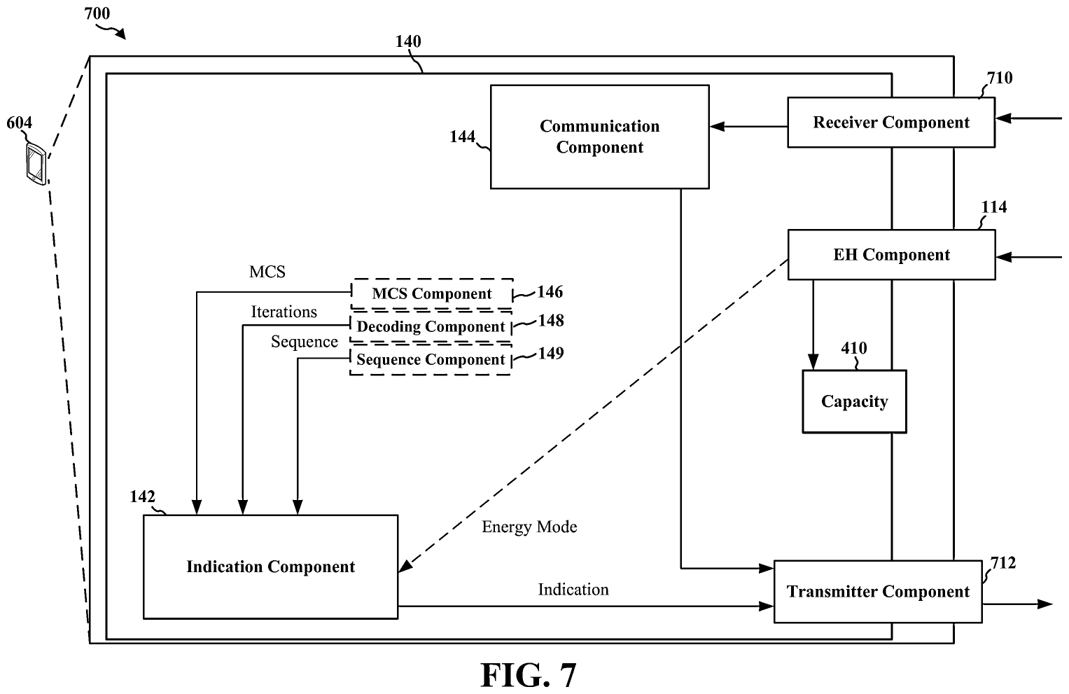

FIG. 7 is a conceptual data flow diagram 700 illustrating the data flow between different means/components in an example UE 604, which may be an example of the UE 104 (or UE 350) including the EH control component 140 and the EH component 114 with reference to FIGS. 1, 3, and 6. The EH control component 140 may be implemented by the memory 360 and the TX processor 368, the RX processor 356, and/or the controller/processor 359. For example, the memory 360 may store executable instructions defining the EH control component 140 and the TX processor 368, the RX processor 356, and/or the controller/processor 359 may execute the instructions.

The UE 604 may include a receiver component 710, which may include, for example, a radio frequency (RF) receiver for receiving the signals described herein. The UE 604 may include a transmitter component 712, which may include, for example, an RF transmitter for transmitting the signals described herein. In an aspect, the receiver component 710 and the transmitter component 712 may co-located in a transceiver such as illustrated by the TX/RX 354 in FIG. 3.

As discussed above, the EH control component 140 may include the indication component 142 and the communication component 144. The EH control component 140 may optionally include the MCS component 146, the decoding component 148, and/or the sequence component 149.

The receiver component 710 may receive various signals including the EH configuration 620, the ACK/NACK 640, and communications 670. The receiver component 710 may provide the EH configuration 620, the ACK/NACK 640, and communications 670 to the communication component 144.

In an aspect, the indication component 142 may determine a maximum time-frequency resource size for one or more physical channels during a time period based on an energy mode of the UE 604 for the time period. For example, the indication component 142 may receive an indication of the energy mode from the EH component 114. The indication component 142 may also receive inputs from the MCS component 146, decoding component 148, or sequence component 149 when included. The indication component 142 may transmit the indication 630 via the transmitter component 712.

The communication component 144 may transmit or receive a signal satisfying the maximum time-frequency resource size on the one or more physical channels. For example, the communication component 144 may receive a signal via the receiver component 710. The communication component 144 may decode the received signal to determine information transmitted by the base station 602 or a sidelink UE. The communication component 144 may generate uplink or sidelink transmissions. The communication component 144 may transmit the uplink or sidelink transmissions via the transmitter component 712.

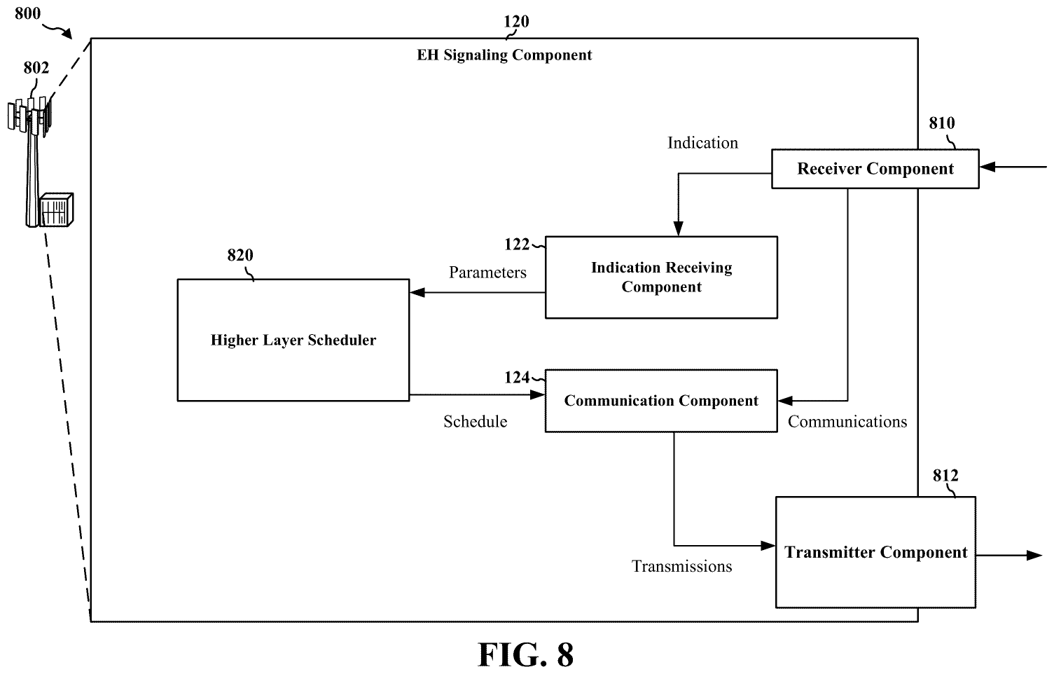

FIG. 8 is a conceptual data flow diagram 800 illustrating the data flow between different means/components in an example scheduling device 802, which may be an example of the base station 102, the base station 310, or the base station 602 and include the EH signaling component 120 with reference to FIGS. 1, 3, and 6. In some implementations, the scheduling device 802 may be a UE including the EH signaling component 120. For example, a sidelink UE may include the EH signaling component 120 and perform scheduling for the EH UE 604.

The EH signaling component 120 may be implemented by the memory 376 and the TX processor 316, the RX processor 370, and/or the controller/processor 375 of FIG. 3. For example, the memory 376 may store executable instructions defining the EH signaling component 120 and the TX processor 316, the RX processor 370, and/or the controller/processor 375 may execute the instructions. As discussed briefly above with respect to FIG. 1, the EH signaling component 120 may include the indication receiving component 122 and the communication component 124. The EH signaling component 120 may further include a higher layer scheduler 820.

The scheduling device 802 may include a receiver component 810, which may include, for example, a RF receiver for receiving the signals described herein. For example, the receiver component 810 may receive the EH capabilities 610, the indication 630, the communications 670 or the CSI 680. The receiver component 810 may provide the EH capabilities 610 and the indication 630 to the indication receiving component 122. The receiver component 810 may provide the communications 670 and the CSI 680 to the communication component 124. The scheduling device 802 may include a transmitter component 812, which may include, for example, an RF transmitter for transmitting the signals described herein. In an aspect, the receiver component 810 and the transmitter component 812 may co-located in a transceiver such as illustrated by the TX/RX 318 in FIG. 3.

The indication receiving component 122 may be configured to receive an indication of a maximum time-frequency resource size for one or more physical channels during a time period based on an energy mode of the UE for the time period. For example, the indication receiving component 122 may receive the indication 630 via the receiver component 810. In implementations where the indication 630 is an RRC message, a MAC-CE, PUCCH, or PUSCH for uplink or downlink physical channels or a PC5-RRC message, MAC-CE, PSFCH, or PSSCH for sidelink physical channels, the indication receiving component 122 may decode the indication 630 according to the message type to determine indicated parameters including the maximum time-frequency resource size 632. In implementations where the indication 630 is received as a sequence on a selected one of the time and frequency occasions 530, the indication receiving component 122 may determine the indication corresponding to the time and frequency occasion 530. The indication receiving component 122 may identify the UE that transmitted the indication 630 based on a cyclic shift of the sequence or by the RNTI. The indication receiving component 122

The EH signaling component 120 may include a higher layer scheduler 820 that determines communications for one or more UEs based at least in part on indicated parameters including the maximum time-frequency resource size 632. For example, when making scheduling decisions, the higher layer scheduler 820 may limit the scheduled communications based on the indicated parameters. The higher layer scheduler 820 may provide scheduling information to the communication component 124.

The communication component 124 may be configured to transmit or receive a signal satisfying the maximum time-frequency resource size on the one or more physical channels. For example, the communication component 124 may transmit a control message (e.g., DCI or SCI) that schedules a transmission or reception on a physical data channel according to the scheduling information from the higher layer scheduler 820. The communication component 124 may then transmit transmissions via the transmitter component 812 or receive communications via the receiver component 810.

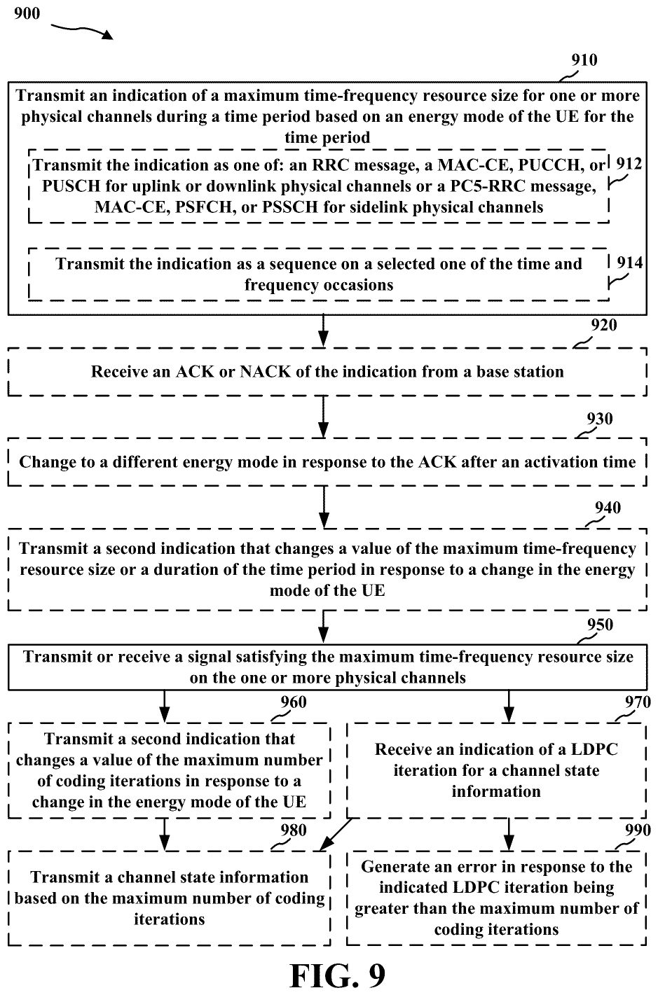

FIG. 9 is a flowchart of an example method 900 for communication by an EH UE. The method 900 may be performed by a UE (such as the UE 104, which may include the memory 360 and which may be the entire UE 104 or a component of the UE 104 such as the EH control component 140, the EH component 114, TX processor 368, the RX processor 356, or the controller/processor 359). The method 900 may be performed by the EH control component 140 in communication with the EH signaling component 120 of the scheduling device 802.

At block 910, the method 900 includes transmitting an indication of a maximum time-frequency resource size for one or more physical channels during a time period based on an energy mode of the UE for the time period. In an aspect, for example, the UE 104, the TX processor 368 and/or the controller/processor 359 may execute the EH control component 140 and/or the indication component 142 to transmit an indication 630 of a maximum time-frequency resource size 632 for one or more physical channels during a time period 634 based on an energy mode of the UE for the time period. For example, the indication 630 may correspond to an index of a pre-defined set of time-frequency resource combinations. For example, at sub-block 912, the block 910 may include transmitting the indication as one of: an RRC message, a MAC-CE, PUCCH, or PUSCH for uplink or downlink physical channels or a PC5-RRC message, MAC-CE, PSFCH, or PSSCH for sidelink physical channels. For sidelink physical channels, the indication 630 may correspond to a resource pool for sidelink communications and the physical channel may be a PSSCH received on resources selected from the resource pool. In some implementations, the UE is configured with a CC 510 and BWP 520 for the indication 630. For example, the BWP 520 may include a set of time and frequency occasions 530 for the indication 630. For instance, at sub-block 914, the block 910 may transmitting the indication as a sequence on a selected one of the time and frequency occasions 530. In some implementations, the indication 630 indicates a maximum transport block size 640, a maximum MCS 642, or a maximum coding rate 644. In some implementations, the indication 630 indicates a maximum number of coding iterations 646 based on the energy mode. In some implementations, the indication 630 includes a minimum time separation 636 between signals based on the energy mode. Accordingly, the UE 104, the TX processor 368, and/or the controller/processor 359 executing the EH control component 140 and/or the indication component 142 may provide means for transmitting an indication of a maximum time-frequency resource size for one or more physical channels during a time period based on an energy mode of the UE for the time period.

At block 920, the method 900 may optionally include receiving an ACK or NACK of the indication from a base station. In an aspect, for example, the UE 104, the RX processor 356 and/or the controller/processor 359 may execute the EH control component 140 and/or the receiver component 710 to receive the ACK/NACK 540, 640 of the indication 630 from a base station. Accordingly, the UE 104, the RX processor 356, and/or the controller/processor 359 executing the EH control component 140 and/or the receiver component 710 may provide means for receiving an ACK or NACK of the indication from a base station.

At block 930, the method 900 may optionally include changing to a different energy mode in response to the ACK after an activation time. In an aspect, for example, the UE 104, the RX processor 356 and/or the controller/processor 359 may execute the EH control component 140 and/or the EH component 114 to change to a different energy mode in response to the ACK after an activation time. Accordingly, the UE 104, the RX processor 356, and/or the controller/processor 359 executing the EH control component 140 and/or the EH component 114 may provide means for changing to a different energy mode in response to the ACK after an activation time.

At block 940, the method 900 may optionally include transmitting a second indication that changes a value of the maximum time-frequency resource size or a duration of the time period in response to a change in the energy mode of the UE. In an aspect, for example, the UE 104, the TX processor 368, and/or the controller/processor 359 may execute the EH control component 140 and/or the indication component 142 to transmit a second indication 630 that changes a value of the maximum time-frequency resource size 632 or a duration of the time period 634 in response to a change in the energy mode of the UE. Accordingly, the UE 104, the TX processor 368, and/or the controller/processor 359 executing the EH control component 140 and/or the indication component 142 may also be configured for transmitting a second indication that changes a value of the maximum time-frequency resource size or a duration of the time period in response to a change in the energy mode of the UE.

At block 950, the method 900 includes transmitting or receiving a signal satisfying the maximum time-frequency resource size on the one or more physical channels. In an aspect, for example, the UE 104, TX processor 368, the RX processor 356 and/or the controller/processor 359 may execute the EH control component 140 and/or the communication component 144 to transmit or receive a signal satisfying the maximum time-frequency resource size 632 on the one or more physical channels. In some implementations, transmitting or receiving the signal is based on a dynamic grant, semi-persistent scheduling, or configured grant that schedules at least the minimum time separation 636 between signals based on the indication 630. Accordingly, the UE 104, the RX processor 356, TX processor 368, and/or the controller/processor 359 executing the EH control component 140 and/or the communication component 144 may provide means for transmitting or receiving a signal satisfying the maximum time-frequency resource size on the one or more physical channels.

At block 960, the method 900 may optionally include transmitting a second indication that changes a value of the maximum number of coding iterations in response to a change in the energy mode of the UE. In an aspect, for example, the UE 104, the TX processor 368, and/or the controller/processor 359 may execute the EH control component 140 and/or the indication component 142 to transmit a second indication that changes a value of the maximum number of coding iterations in response to a change in the energy mode of the UE. Accordingly, the UE 104, the TX processor 368, and/or the controller/processor 359 executing the EH control component 140 and/or the indication component 142 may also be configured to transmit a second indication that changes a value of the maximum number of coding iterations in response to a change in the energy mode of the UE.

At block 970, the method 900 may optionally include receiving an indication of a LDPC iteration for a channel state information. In an aspect, the UE 104, the RX processor 356 and/or the controller/processor 359 may execute EH control component 140 and/or the communication component 144 to receive an indication of a LDPC iteration for the CSI 680. Accordingly, the UE 104, the RX processor 356, and/or the controller/processor 359 executing the EH control component 140 and/or the communication component 144 may provide means for receiving an indication of a LDPC iteration for a channel state information.

At block 980, the method 900 may optionally include transmitting a channel state information based on the maximum number of coding iterations. In an aspect, the UE 104, the TX processor 368, and/or the controller/processor 359 may execute EH control component 140 and/or the communication component 144 to transmit the CSI 680 based on the maximum number of coding iterations 646. Accordingly, the UE 104, the TX processor 368, and/or the controller/processor 359 executing the EH control component 140 and/or the communication component 144 may provide means for transmitting a channel state information based on the maximum number of coding iterations.

At block 990, the method 900 may optionally include generating an error in response to the indicated LDPC iteration being greater than the maximum number of coding iterations. In an aspect, the UE 104, the TX processor 368 and/or the controller/processor 359 may execute EH control component 140 and/or the communication component 144 to generate an error in response to the indicated LDPC iteration being greater than the maximum number of coding iterations 646. Accordingly, the UE 104, the TX processor 368, and/or the controller/processor 359 executing the EH control component 140 and/or the communication component 144 may provide means for generating an error in response to the indicated LDPC iteration being greater than the maximum number of coding iterations.

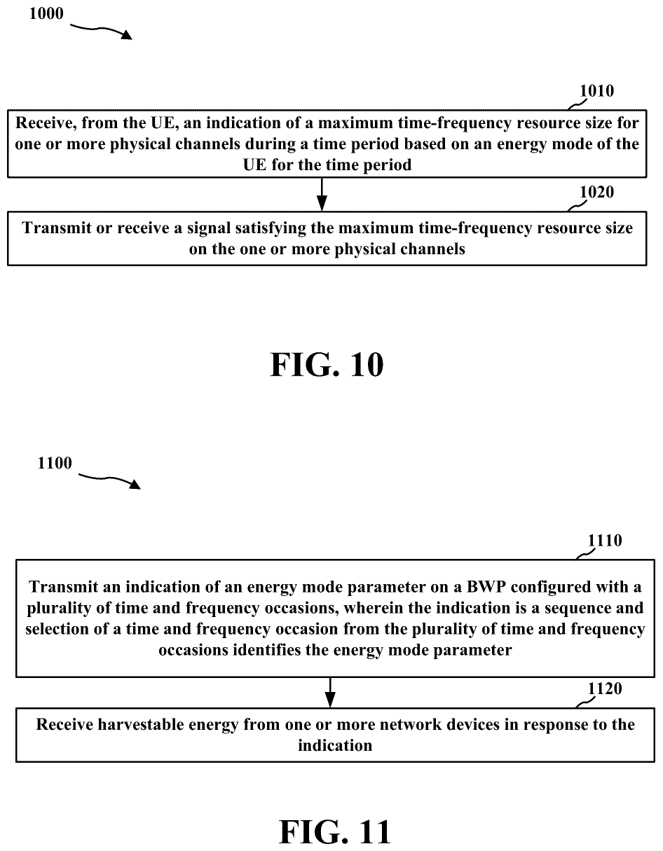

FIG. 10 is a flowchart of an example method 1000 for communicating with an EH UE. The method 1000 may be performed by a scheduling device 802 (such as the base station 102, the base station 310, or the base station 602), which may include the memory 376 and which may be the entire scheduling device 802 or a component of the scheduling device 802 such as the μF signaling component 120, TX processor 316, the RX processor 370, or the controller/processor 375). The method 1000 may be performed by the EH signaling component 120 in communication with the EH control component 140 of the UE 104.

At block 1010, the method 1000 includes receiving, from the UE, an indication of a maximum time-frequency resource size for one or more physical channels during a time period based on an energy mode of the UE for the time period. In an aspect, for example, the scheduling device 802, the controller/processor 375, the RX processor 370, and/or the TX processor 316 may execute the EF signaling component 120 and/or the indication receiving component 122 to receive, from the UE, an indication of a maximum time-frequency resource size for one or more physical channels during a time period based on an energy mode of the UE for the time period. Accordingly, the scheduling device 802, the controller/processor 375, and/or the TX processor 316 executing the EF signaling component 120 and/or the indication receiving component 122 may provide means for receiving, from the UE, an indication of a maximum time-frequency resource size for one or more physical channels during a time period based on an energy mode of the UE for the time period.

At block 1020, the method 1000 includes transmitting or receiving a signal satisfying the maximum time-frequency resource size on the one or more physical channels. In an aspect, for example, the scheduling device 802, the controller/processor 375, the RX processor 370 and/or the TX processor 316 may execute the EF signaling component 120 and/or the communication component 124 to transmit or receive a signal satisfying the maximum time-frequency resource size on the one or more physical channels. Accordingly, the scheduling device 802, the controller/processor 375, and/or the TX processor 316 executing the EF signaling component 120 and/or the communication component 124 may provide means for transmitting or receiving a signal satisfying the maximum time-frequency resource size on the one or more physical channels.

FIG. 11 is a flowchart of an example method 1100 for harvesting energy at a UE. The method 1100 may be performed by a UE (such as the UE 104, which may include the memory 360 and which may be the entire UE 104 or a component of the UE 104 such as the EH control component 140, the EH component 114, TX processor 368, the RX processor 356, or the controller/processor 359). The method 1100 may be performed by the EH control component 140 in communication with the EH signaling component 120 of the scheduling device 802.

At block 1110, the method 1100 includes transmitting an indication of an energy mode parameter on a BWP configured with a plurality of time and frequency occasions. In an aspect, for example, the UE 104, the TX processor 368 and/or the controller/processor 359 may execute the EH control component 140 and/or the indication component 142 to transmit the indication 630 of an energy mode parameter on a BWP 520 configured with a plurality of time and frequency occasions 530. The indication 630 may be a sequence, and selection of a time and frequency occasion from the plurality of time and frequency occasions 530 identifies the energy mode parameter. Accordingly, the UE 104, the TX processor 368, and/or the controller/processor 359 executing the EH control component 140 and/or the indication component 142 may provide means for transmitting an indication of an energy mode parameter on a BWP configured with a plurality of time and frequency occasions.

At block 1120, the method 1100 includes receiving harvestable energy from one or more network devices in response to the indication. In an aspect, for example, the UE 104, the RX processor 356 and/or the controller/processor 359 may execute the EH control component 140 and/or the EH component 114 to receive harvestable energy from one or more network devices 606 in response to the indication 630. Accordingly, the UE 104, the RX processor 356, and/or the controller/processor 359 executing the EH control component 140 and/or the EH component 114 may provide means for receiving harvestable energy from one or more network devices in response to the indication.

### Some Further Example Clauses

Implementation examples are described in the following numbered clauses:
1. A method of wireless communication for a user equipment (UE), comprising:
transmitting an indication of a maximum time-frequency resource size for one or more physical channels during a time period based on an energy mode of the UE for the time period; and
transmitting or receiving a signal satisfying the maximum time-frequency resource size on the one or more physical channels.
   2. The method of clause 1, wherein the indication corresponds to an index of a configured set of time-frequency resource combinations.
   3. The method of clause 2, further comprising receiving a configuration of at least one of the set of time-frequency resource combinations as one of:
a radio resource control (RRC) message,
a media access control (MAC)-control element (CE),
information multiplexed with a wake up signal (WUS),
a dedicated physical downlink shared channel (PDSCH),
a dedicated physical sidelink shared channel (PSSCH),
a downlink control information (DCI), or
a sidelink control information (SCI).
   4. The method of claim 1, wherein transmitting the indication comprises transmitting the indication, for uplink physical channels or downlink physical channels, as one of:
a radio resource control (RRC) message,
a media access control (MAC)-control element (CE),
a dedicated physical uplink control channel (PUCCH),
information multiplexed with a HARQ-ACK of one or more of downlink transmissions carried on PUCCH,
information multiplexed with a scheduling request (SR),
information multiplexed with a buffer state information (BSR), or information multiplexed with a random-access message, or
a physical uplink shared channel (PUSCH); or,
   for sidelink physical channels, as one of:
a PC5-RRC message,
a PC5-MAC-CE,
a dedicated physical sidelink feedback channel (PSFCH),
a physical sidelink shared channel (PSSCH),
a physical sidelink control channel (PSCCH), or
information multiplexed with a HARQ-ACK of one or more PSSCH carried on PSFCH.
   5. The method of any of clauses 1-4, wherein the indication corresponds to a resource pool for sidelink communications and the physical channel is a PSSCH received on resources selected from the resource pool.
   6. The method of any of clauses 1-5, further comprising transmitting a second indication that changes a value of the maximum time-frequency resource size or a duration of the time period in response to a change in the energy mode of the UE.
   7. The method of any of clauses 1-6, wherein the indication further indicates a maximum transport block size, a maximum modulation and coding scheme (MCS), or a maximum coding rate.
   8. The method of any of clauses 1-7, wherein the indication further indicates a maximum number of decoding iterations based on the energy mode.
   9. The method of clause 8, further comprising transmitting a channel state information based on the maximum number of decoding iterations.
   10. The method of clause 9, wherein a number of bits of the channel state information is based on a number of supported modulation and coding schemes for the energy mode.
   11. The method of clause 8, further comprising:
receiving an indication of a low density parity code (LDPC) iteration for a channel state information; and
generating an error in response to the indicated LDPC iteration being greater than the maximum number of decoding iterations.
   12. The method of any of clauses 8-11, further comprising transmitting a second indication that changes a value of the maximum number of decoding iterations in response to a change in the energy mode of the UE.
   13. The method of any of clauses 1-12, wherein the indication includes a minimum separation in time between signals based on the energy mode, and wherein transmitting or receiving the signal is based on a dynamic grant, semi-persistent scheduling, or configured grant that schedules at least the minimum separation in time between signals based on the indication.
   14. The method of any of clauses 1-13, wherein the UE is configured with a component carrier and bandwidth part (BWP) for the indication.
   15. The method of clause 14, wherein the BWP includes a set of time and frequency occasions, and wherein transmitting the indication comprises transmitting the indication as a sequence on a selected one of the time and frequency occasions.
   16. The method of clause 15, wherein the sequence indicates a request for energy from one or more network devices or a request to reduce a data component carrier.
   17. The method of clause 14, wherein a selected one of the time and frequency occasions indicates an amount of energy for the UE to reach a power state.
   18. The method of clause 14, wherein the set of time and frequency occasions includes one or more subsets corresponding to different energy modes.
   19. The method of clause 18, wherein the different energy modes are associated with different charging rates provided by one or more network devices.
   20. The method of any of clauses 14-19, further comprising receiving an acknowledgment (ACK) or negative acknowledgment (NACK) of the indication from a base station.
   21. The method of clause 20, further comprising changing to a different energy mode in response to the ACK after an activation time.
   22. An apparatus for wireless communication, comprising:
a transceiver;
a memory storing computer-executable instructions; and
a processor coupled with the transceiver and the memory and configured to execute the computer-executable instructions to perform the method of any of clauses 1-21.
   23. An apparatus for wireless communication, comprising:
means for performing the method of any of clauses 1-21.
   24. A non-transitory computer-readable medium storing computer executable code, the code when executed by a processor causes the processor to perform the method of any of clauses 1-21.
   25. A method of wireless communication with an energy harvesting user equipment (UE), comprising:
receiving, from the UE, an indication of a maximum time-frequency resource size for one or more physical channels during a time period based on an energy mode of the UE for the time period; and
transmitting or receiving a signal satisfying the maximum time-frequency resource size on the one or more physical channels.
   26. The method of clause 25, wherein the indication corresponds to an index of a configured set of time-frequency resource combinations.
   27. The method of clause 25 or 26, wherein receiving the indication comprises receiving the indication as one of: an RRC message, a MAC-CE, PUCCH, or PUSCH for uplink or downlink physical channels or a PC5-RRC message, MAC-CE, PSFCH, PSCCH, or PSSCH for sidelink physical channels.
   28. The method of clause 25 or 26, wherein the indication corresponds to a resource pool for sidelink communications and the physical channel is a PSSCH received on resources selected from the resource pool.
   29. The method of any of clauses 25-28, further comprising receiving a second indication that changes a value of the maximum time-frequency resource size or a duration of the time period in response to a change in the energy mode of the UE.
   30. The method of any of clauses 25-29, wherein the indication further indicates a maximum transport block size, a maximum modulation and coding scheme (MCS), or a maximum coding rate.
   31. The method of any of clauses 25-30, wherein the indication further indicates a maximum number of decoding iterations based on the energy mode.
   32. The method of clause 31, further comprising receiving a channel state information based on the maximum number of decoding iterations.
   33. The method of clause 32, wherein a number of bits of the channel state information is based on a number of supported modulation and coding schemes for the energy mode.
   34. The method of any of clauses 31-33, further comprising receiving a second indication that changes a value of the maximum number of decoding iterations in response to a change in the energy mode of the UE.
   35. The method of any of clauses 25-34, wherein the indication includes a minimum separation in time between signals based on the energy mode, and wherein transmitting or receiving the signal is based on a dynamic grant, semi-persistent scheduling, or configured grant that schedules at least the minimum separation in time between signals based on the indication.
   36. The method of any of clauses 25-35, wherein the UE is configured with a component carrier and bandwidth part (BWP) for the indication.
   37. The method of clause 36, wherein the BWP includes a set of time and frequency occasions, and wherein receiving the indication comprises receiving the indication as a sequence on a selected one of the time and frequency occasions.
   38. The method of clause 37, wherein the sequence indicates a request for energy from one or more network devices.
   39. The method of clause 37, wherein the sequence indicates a request to reduce a data component carrier.
   40. The method of clause 37, wherein a selected one of the time and frequency occasions indicates an amount of energy for the UE to reach a power state.
   41. The method of clause 37, wherein the set of time and frequency occasions includes one or more subsets corresponding to different energy modes.
   42. The method of clause 41, wherein the different energy modes are associated with different charging rates provided by one or more network devices.
   43. An apparatus for wireless communication, comprising:
a transceiver;
a memory storing computer-executable instructions; and
a processor coupled with the transceiver and the memory and configured to execute the computer-executable instructions to perform the method of any of clauses 25-42.
   44. An apparatus for wireless communication, comprising:
means for performing the method of any of clauses 25-42.
   45. A non-transitory computer-readable medium storing computer executable code, the code when executed by a processor causes the processor to perform the method of any of clauses 25-42.
   46. A method of wireless communication for a user equipment (UE), comprising:
transmitting an indication of an energy mode parameter on a bandwidth part (BWP) configured with a plurality of time and frequency occasions, wherein the indication is a sequence and selection of a time and frequency occasion from the plurality of time and frequency occasions identifies the energy mode parameter; and
receiving harvestable energy from one or more network devices in response to the indication.
   47. The method of clause 46, wherein the sequence indicates a request for energy from one or more network devices.
   48. The method of clause 46, wherein the sequence indicates a request to reduce a data component carrier.
   49. The method of clause 46, wherein a selected one of the time and frequency occasions indicates an amount of energy for the UE to reach a power state.
   50. The method of clause 46, wherein the set of time and frequency occasions includes one or more subsets corresponding to different energy modes.
   51. The method of clause 50, wherein the different energy modes are associated with different charging rates provided by the one or more network devices.
   52. The method of any of clauses 46-51, further comprising receiving an acknowledgment (ACK) or negative acknowledgment (NACK) of the indication from a base station.
   53. The method of clause 52, further comprising changing to a different energy mode in response to the ACK after an activation time.
   54. An apparatus for wireless communication, comprising:
a transceiver;
a memory storing computer-executable instructions; and
a processor coupled with the transceiver and the memory and configured to execute the computer-executable instructions to perform the method of any of clauses 46-53.
   55. An apparatus for wireless communication, comprising:
means for performing the method of any of clauses 46-53.
   56. A non-transitory computer-readable medium storing computer executable code, the code when executed by a processor causes the processor to perform the method of any of clauses 46-53.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication for a user equipment (UE), comprising:
transmitting an indication of a maximum time-frequency resource size for one or more physical channels during a time period based on an energy mode of the UE for the time period; and
transmitting or receiving a signal satisfying the maximum time-frequency resource size on the one or more physical channels.

2. The method of claim 1, wherein the indication corresponds to an index of a configured set of time-frequency resource combinations defining a number of symbols and a number of resource elements or resource blocks.

3. The method of claim 2, further comprising receiving a configuration of at least one of the set of time-frequency resource combinations as one of:
a radio resource control (RRC) message,
a media access control (MAC)-control element (CE),
information multiplexed with a wake up signal (WUS),
a dedicated physical downlink shared channel (PDSCH),
a dedicated physical sidelink shared channel (PSSCH),
a downlink control information (DCI), or
a sidelink control information (SCI).

4. The method of claim 1, wherein transmitting the indication comprises transmitting the indication, for uplink physical channels or downlink physical channels, as one of:
a radio resource control (RRC) message,
a media access control (MAC)-control element (CE),
a dedicated physical uplink control channel (PUCCH),
information multiplexed with a HARQ-ACK of one or more of downlink transmissions carried on PUCCH,
information multiplexed with a scheduling request (SR),
information multiplexed with a buffer state information (BSR), or information multiplexed with a random-access message, or
a physical uplink shared channel (PUSCH); or,
for sidelink physical channels, as one of:
a PC5-RRC message,
a MAC-CE,
a dedicated physical sidelink feedback channel (PSFCH),
a physical sidelink shared channel (PSSCH),
a physical sidelink control channel (PSCCH), or
information multiplexed with a HARQ-ACK of one or more PSSCH carried on PSFCH.

5. The method of claim 1, wherein the indication corresponds to a resource pool for sidelink communications and the physical channel is a PSSCH received on resources selected from the resource pool.

6. The method of claim 1, further comprising transmitting a second indication that changes a value of the maximum time-frequency resource size or a duration of the time period in response to a change in the energy mode of the UE.

7. The method of claim 1, wherein the indication further indicates a maximum transport block size, a maximum modulation and coding scheme (MCS), or a maximum coding rate.

8. The method of claim 1, wherein the indication further indicates a maximum number of decoding iterations based on the energy mode.

9. The method of claim 8, further comprising transmitting a channel state information based on the maximum number of decoding iterations.

10. The method of claim 9, wherein a number of bits of the channel state information is based on a number of supported modulation and coding schemes for the energy mode.

11. The method of claim 8, further comprising:
receiving an indication of a low density parity code (LDPC) iteration for a channel state information; and
generating an error in response to the indicated LDPC iteration being greater than the maximum number of decoding iterations.

12. The method of claim 8, further comprising transmitting a second indication that changes a value of the maximum number of decoding iterations in response to a change in the energy mode of the UE.

13. The method of claim 1, wherein the indication includes a minimum separation in time between signals based on the energy mode, and wherein transmitting or receiving the signal is based on a dynamic grant, semi-persistent scheduling, or configured grant that schedules at least the minimum separation in time between signals based on the indication.

14. The method of claim 1, wherein the UE is configured with a component carrier and bandwidth part (BWP) for the indication.

15. The method of claim 14, wherein the BWP includes a set of time and frequency occasions, and wherein transmitting the indication comprises transmitting the indication as a sequence on a selected one of the time and frequency occasions.

16. The method of claim 15, wherein the sequence indicates a request for energy from one or more network devices or a request to reduce a data component carrier.

17. The method of claim 15, wherein a selected one of the time and frequency occasions indicates an amount of energy for the UE to reach a power state.

18. The method of claim 15, wherein the set of time and frequency occasions includes one or more subsets corresponding to different energy modes.

19. The method of claim 18, wherein the different energy modes are associated with different charging rates provided by one or more network devices.

20. The method of claim 14, further comprising receiving an acknowledgment (ACK) or negative acknowledgment (NACK) of the indication from a base station.

21. The method of claim 20, further comprising changing to a different energy mode in response to the ACK after an activation time.

22. A method of wireless communication with an energy harvesting user equipment (UE), comprising:
receiving, from the UE, an indication of a maximum time-frequency resource size for one or more physical channels during a time period based on an energy mode of the UE for the time period; and
transmitting or receiving a signal satisfying the maximum time-frequency resource size on the one or more physical channels.

23. The method of claim 22, wherein the indication corresponds to an index of a configured set of time-frequency resource combinations.

24. The method of claim 22, wherein the indication corresponds to a resource pool for sidelink communications and the physical channel is a PSSCH received on resources selected from the resource pool.

25. The method of claim 22, wherein the indication further indicates a maximum transport block size, a maximum modulation and coding scheme (MCS), or a maximum coding rate.

26. The method of claim 22, wherein the indication further indicates a maximum number of decoding iterations based on the energy mode.

27. A method of wireless communication for a user equipment (UE), comprising:
transmitting an indication of an energy mode parameter on a bandwidth part (BWP) configured with a plurality of time and frequency occasions, wherein the indication is a sequence and selection of a time and frequency occasion from the plurality of time and frequency occasions identifies the energy mode parameter; and
receiving harvestable energy from one or more network devices in response to the indication.

28. The method of claim 27, wherein the sequence indicates a request for energy from one or more network devices or a request to reduce a data component carrier.

29. The method of claim 27, wherein a selected one of the time and frequency occasions indicates an amount of energy for the UE to reach a power state.

30. An apparatus for wireless communication at a user equipment (UE), comprising:
a memory storing computer-executable instructions; and
at least one processor communicatively coupled with the memory and configured to execute the instructions to:
transmit an indication of a maximum time-frequency resource size for one or more physical channels during a time period based on an energy mode of the UE for the time period; and
transmit or receive a signal satisfying the maximum time-frequency resource size on the one or more physical channels.
